(19) United States
(12) Patent Application Publication
(10) Pub. No.: US 2024/0273457 A1
(43) Pub. Date: Aug. 15, 2024

(54) HEATMAP-BASED GRAPHS FOR MITIGATING COMPUTATIONAL BURDEN IN WAREHOUSE ROUTING PROBLEMS

(71) Applicant: Dell Products L.P., Round Rock, TX (US)

(72) Inventors: Ítalo Gomes Santana, Rio de Janeiro (BR); Miguel Paredes Quiñones, Campinas (BR); Alexander Eulalio Robles Robles, Valinhos (BR)

(21) Appl. No.: 18/167,327

(22) Filed: Feb. 10, 2023

(51) Int. Cl. G06Q 10/0835

(52) U.S. Cl. CPC G06Q 10/08355; G06Q 10/087

(57) ABSTRACT

One example method includes obtaining a group of historical itineraries, where each itinerary in the group of historical itineraries identifies a route previously taken by a vehicle in an operating environment, generating a heatmap using a model that aggregates the historical itineraries and one or more changes that have occurred in the operating environment since the historical itineraries were generated, deriving a graph from the heatmap, wherein the graph defines a routing problem and comprises a subset of the group of historical itineraries, and using the graph to generate updated itineraries that account for the one or more changes in the operating environment.

### FIELD OF THE INVENTION

Embodiments of the present invention generally relate to task planning for entities operating in a physical environment. More particularly, at least some embodiments of the invention relate to systems, hardware, software, computer-readable media, and methods, for managing computational burdens involved in task planning.

### BACKGROUND

Increasing throughput in physical environments such as warehouses is a challenging topic given the myriad of dynamics involved in managing a fleet of autonomous vehicles to fulfill all required tasks. These problems, which are typically modelled under many complicated constraints, are onerous for optimization solvers to provide high-quality itineraries that meet all demanding tasks. In particular, the computational burdens involved in generating itineraries for the vehicles can be significant, particularly in circumstances where there are numerous vehicles that are expected to each perform a variety of tasks. While some approaches have been devised in attempts to mitigate the computational burden involved in generating vehicle itineraries, such approaches suffer from various problems, not the least of which is their inability to account for changes that may have occurred, and are occurring, in the operating environment after the itineraries have been generated.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment according to one embodiment.

FIG. 2 discloses aspects of an example method according to one embodiment.

FIG. 3 discloses aspects of an example heatmap according to one embodiment.

FIGS. 4a, 4b, 4c, and 4d, disclose aspects of a graph, and a method for repairing the graph, according to one embodiment.

FIG. 5 discloses an example computing entity configured and operable to perform any of the disclosed methods, processes, and operations.

### DETAILED DESCRIPTION OF SOME EXAMPLE EMBODIMENTS

Embodiments of the present invention generally relate to task planning for entities operating in a physical environment. More particularly, at least some embodiments of the invention relate to systems, hardware, software, computer-readable media, and methods, for managing computational burdens involved in task planning.

In general, one embodiment of the invention comprises an approach that reduces the computational burden of task planning, relative to the computational burden that would be imposed by approaches that do not employ the techniques disclosed herein, by using past itineraries concerning the current dynamics in the warehouse. Specifically, one embodiment of the invention comprises generating a heatmap based on past vehicle movements in a physical operating environment, such as a warehouse for example, and also based on the current dynamics of the operating environment, where such dynamics may comprise, for example, a change that has taken place in the physical configuration of the operating environment after the past vehicle movements occurred. Next, an alternative graph may be derived from the heatmap and served as input to a planning task solver. Because the alternative graph may leverage historical itinerary information, at least to the extent that such information is not affected by environment dynamics, the alternative graph may be significantly smaller than the original graph that was developed for the vehicles and itineraries and, as such, relatively easier to solve, that is, relatively easier to use for generating new and/or modified itineraries after having accounted for environment dynamics. In an embodiment, the aforementioned functionalities may be offered as-a-service (aaS) to customers, and/or in edge solutions for customers that are interested in optimizing operations, such as warehouse operations in the fields of supply chain and logistics.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of one embodiment of the invention is that the embodiment may be able to leverage historical information to perform a computationally efficient generation of vehicle itineraries. An embodiment of the invention may generate vehicle itineraries in a way that accounts for operating environment dynamics and, in this way, help to ensure that collisions and other problems do not occur as a result of such operating environment dynamics. Other advantages of one or more embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

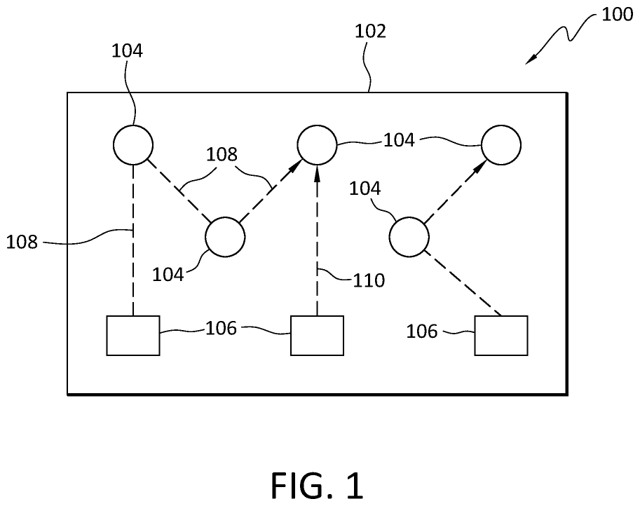

With reference now to FIG. 1, there is disclosed a simplified example of an operating environment 100 according to one embodiment of the invention. In an embodiment, the operating environment 100 may comprise a physical domain 102, one example of which is a warehouse. Note that while reference is made herein to a warehouse, and vehicles such as forklifts and trucks, that may operate in a warehouse, these references are provided for the purpose of illustration and are not intended to limit the scope of the invention in any way.

In the example of FIG. 1, the operating environment 100 may comprise one or more nodes 104, each of which may correspond to a respective physical location in the operating environment 100. As used herein, an ‘edge’ may refer to a path between nodes 104. In general, one or more vehicles 106, which may operate autonomously within the operating environment 100, may travel through and/or to one or more nodes 104 while carrying out one or more tasks which have been assigned to the vehicle(s) 106. The path taken by a vehicle 106 to a destination may be referred to herein as an ‘itinerary.’ As shown in FIG. 1, an itinerary may comprise multiple hops 108, or a single hop 110. By way of illustration, a vehicle 106 may pick up cargo at one node 104, and deliver that cargo to one or more other nodes 104.

### B. Overview of Aspects of One Embodiment

Planning the itinerary for a set of autonomous vehicles in warehouses is a challenging combinatorial problem due to the number of solutions in the search space, which is typically on the order of O(n!) solutions over n demanding tasks. This planning is a combinatorial optimization problem that stands for finding least-cost itineraries, or route, for all vehicles, where each task can only be assigned to one vehicle. In the literature, this problem is referred to as the Vehicle Routing Problem (VRP). Due to the complexity in finding high-quality solutions for this problem, an embodiment may reuse past itineraries to reduce the total computational effort by pruning the search space of solutions, as discussed in further detail below.

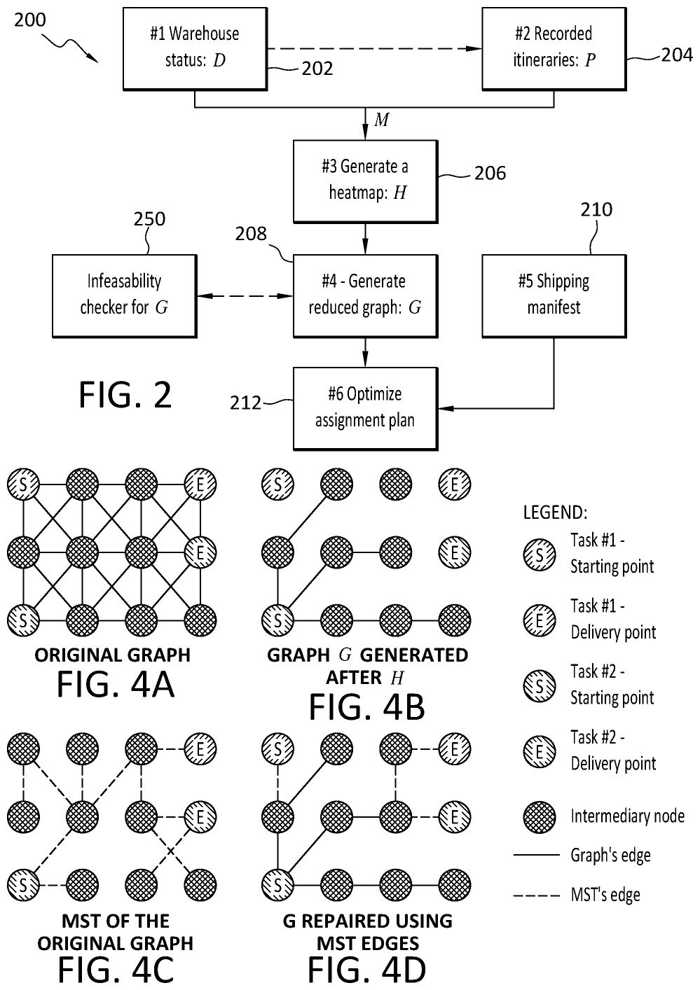

Let a warehouse W and a shipping manifest that contains all available vehicles and all demanding tasks to be assigned. An embodiment may generate a reduced version of the original problem that accounts for the current dynamics of W to an optimization solver. To do so, an embodiment may create a heatmap H based on [1] a model M, [2] past itineraries P and [3] the current dynamics D of W. This heatmap may then be used to create an alternative graph G, which may be used for pruning the search space of solutions for the solver. One example embodiment is detailed below, and in FIG. 2, which discloses a general flowchart which may be used to generate task assignment plans based on previously recorded itineraries.

Initially, and with reference to the example method 200 of FIG. 2, an embodiment may assume that all necessary telemetry data to perform the task planning optimization is available for use as in operation #1 202. Such telemetry data may include, but is not limited to, the warehouse physical boundaries, blocked and traversal areas, vehicle properties and vehicle positions, delivery points, pallet positions, and any other information concerning the warehouse, cargo, and/or vehicles operating in the warehouse. This telemetry data may provide the dynamics needed to form D involved in the warehouse W.

An embodiment may further assume that, in operation #2 204, a database may provide records of past itineraries, where the past itineraries are collectively denoted by P, for retrieval. An embodiment may refine, or reduce, the data retrieval by considering only representative itineraries so as to increase faithfulness of P in relation to D, or to reduce retrieval time, represented by the broken line in FIG. 2. To illustrate, D may be used as a filter to retrieve similar itineraries, such as itineraries that had not used areas that are currently blocked in D. That is, because the portion of the warehouse W where the past similar itineraries traversed has not experienced any relevant changes that would affect future itineraries, an embodiment may assume that the future itineraries may be similar, or identical, to the past itineraries involving those portions of the warehouse W. Note that, to avoid large disruptions in matching P and W, an embodiment may assume that all itineraries in P were performed on W.

In operation #3 206, a heatmap H containing every vehicle movement may be generated using a model M that aggregates P and D. The heatmap H may comprise an adjacency matrix containing values that represents the ‘movement level’ of any vehicle in the traversal between two points. Further details for the generation of values in each matrix cell and the adaptation of D in H are provided below.

In operation #4 208, a graph G may be derived, based on, or from, H. In the graph construction, an edge between a pair of nodes exists if the corresponding matrix cell entry in H has a value greater than a minimum threshold. As a result, G may be expected to become a smaller version of the original problem once only promising edges are included in G in such a way that at least one solution can be determined. Note that, in the worst-case scenario, G will contain the same number of edges as the original problem, particularly when the threshold is sufficiently low. In this case, G will not reduce, relative to the computational load associated with the initial solution to the routing problem, the computational load associated with solving the updated routing problem, that is, the routing problem that has been updated based on D.

Conversely, a threshold that is too high can make G infeasible for the solver, thus causing the optimization to be suspended, since there may be too few edges to enable a solution to be determined. In an embodiment, an infeasibility checker 250 may be used to determine whether or not G is feasible and, when G is determined to be feasible, operation #4 208 may be performed.

In operation #5 210, the shipping manifest, that is, the description of all demanding tasks, their transportation, and all available vehicles to execute these tasks, and G are provided to a solver as in operation #6 212. For the sake of generality, an embodiment may assume this solver is a black-box algorithm that has graph representations as inputs, and which may assign all demanding tasks to the fleet of vehicles. In the literature, (meta)heuristics, and exact solvers are example approaches for tackling VRPs.

Thus, and with reference to the illustrative example of FIG. 2, the original optimization problem, as a graph, may be transformed to a graph version with fewer edges and nodes than were in the original optimization problem and which may take into account past, or historical, itineraries, as well as current warehouse dynamics. Thus, the computational effort in solving a relatively smaller version of the original problem may become less expensive that solving a problem of the same size as the original problem and, in some cases, may be important for solving very-large scale problems. In some cases, a direct unique solution may be obtained from the use of the heat map.

As disclosed herein then, an embodiment may comprise various aspects. One of such aspects concerns the selection of relevant input data. Particularly, since the amount of all recorded itineraries P may be significant in the database, an entity such as a user may select a subset of relevant itineraries P. This filtering approach may be performed by using D in the query. As an example, if there is a blocked area in W, this information may be used to avoid the selection of itineraries that contain routes traversing this blocked area. The objective of performing such a filtering may be twofold, [1] increasing not only the speed in retrieving data and adapting it into the heatmap but also in [2] enhancing the faithfulness of the information contained in the heatmap.

Another aspect of an embodiment concerns the reduction of the size of the original problem, which may thereby reduce the computing load associated with the reduced size problem. Particularly, the reduction in size of the original problem may be achieved using a heatmap to derive a reduced version of the same problem. On the reduced size graph, an embodiment may reduce the size of the solution search by discarding unpromising edges for the optimization process according to a minimum threshold. Fewer edges or nodes on the graph may have dramatic effects in reducing the size of the search space since this kind of search space increases combinatorically with the number of edges and nodes.

### C. Detailed Description

As noted, and in contrast with one embodiment of the invention, conventional approaches to reducing a problem size do not consider a post processing approach that accounts for the dynamics D, nor do such approaches employ similar, historical, itineraries P involved in the warehouse.

### C.1 Heatmap Values and Adaptation of D in H

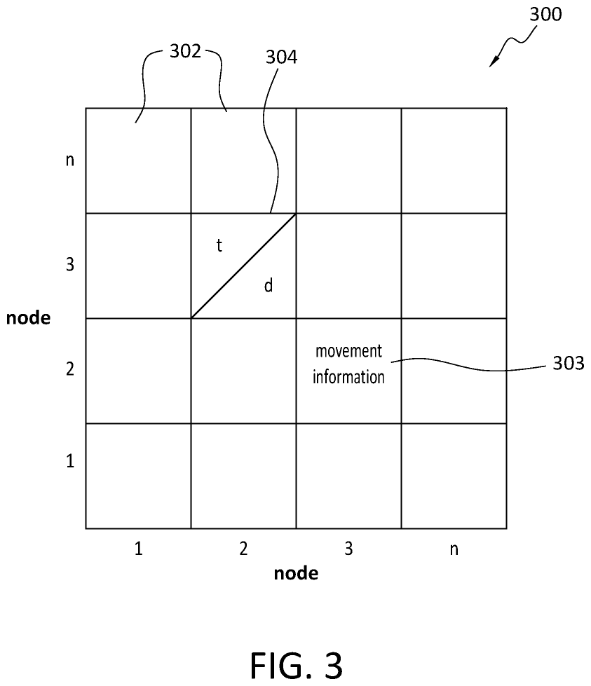

An embodiment may employ a discretization representation of a warehouse in the form of a grid map, and may assume a vehicle passing through an area in W has a corresponding set of cells in the grid map. Therefore, an embodiment may assume that each possible traversal between two points in the warehouse is mapped into H. Reference is now made to FIG. 3 which discloses an example of a heatmap H, denoted generally at 300.

As shown in FIG. 3, the heatmap 300 may comprise a matrix, of size node X node, that includes all the nodes, represented by cells 302, in an operating environment. An operating environment may have any number ‘n’ nodes. In general, a cell, such as the example cell 303, may comprise information relating to any aspect of a movement of a vehicle between one node and another node. With particular reference to the cell 304, that cell 304 concerns travel between node 2 and node 3. In the example of FIG. 3, the cell 304 comprises time ‘t’ and/or distance ‘d’ information relating to movement of a vehicle between node 2 and node 3. That is, the information in the example cell 304 indicates how far, in physical terms, node 2 and node 3 are from each other. The cell 304 also indicates how much time it took for a vehicle to move, as part of an itinerary, between node 2 and node 3.

For the sake of simplicity, an embodiment may subdivide the process of generating H into two parts, namely, (1) generating H by P, followed by (2) applying D in H. In this process, an embodiment may assume the use of a model M that performs these two operations.

For (1), an embodiment may assume that a generic routine can aggregate the past itineraries P into H by calculating the values for each matrix cell. Two examples are provided for performing these calculations. In the first example, an embodiment may assume a ‘by inspection’ approach, where the frequency of the same pair of nodes in all itineraries of P is set into the corresponding matrix cell. In other words, the frequency of the same pair of nodes in occurring in P is included in H. In the second example, an embodiment may use the approach disclosed in Kool, W., Van Hoof, H., Gromicho, J. and Welling, Max. 2022. Deep Policy Dynamic Programming for Vehicle Routing Problems. International Conference on the Integration of Constraint Programming, Artificial Intelligence, and Operations Research (CPAIOR) (“Kool”) (incorporated herein in its entirety by this reference) to generate a heatmap of probabilities of each edge in participating in a high-quality solution. In this example, P may be used as training set for a graph neural network, and the original problem is given as test example to this network to predict these probabilities. Note that, in both examples, an embodiment may define a minimum threshold to prune unpromising edges, thus, reducing the problem size and, correspondingly, the computational workload associated with determining a solution to the problem.

For (2), an embodiment may assume that D comprises all necessary information that represents the current state of W to be used into H. The sources of such information are described in operation #1 202, discussed above. The application of D stands for decreasing or nullifying the values of some matrix cells in H. For instance, a blocked area in the W corresponds to make the solver disregard this area in the optimization process, since it can be assumed that a vehicle will not travel through the blocked area. Therefore, all corresponding matrix cells in the heatmap should not be present in G, that is, these matrix cells to be disregarded may be zeroed. In other situations, user-defined values may decrease these values in the matrix cells to make the corresponding edges less relevant for G.

C.2 Dealing with Infeasibility in the Graph

In situations where the number of pruned edges makes G infeasible, that is, makes G a disconnected graph, an embodiment may execute a procedure to repair this graph. Recall that a disconnected graph may contain many connected components, that is, connected subgraphs, and an embodiment may leverage on this property to implement the following procedure.

First, an embodiment may run a traversal algorithm on G that marks all visited nodes, that is, all nodes to which a vehicle has traveled in the past, where one example traversal algorithm comprises a breadth-first search which runs in polynomial time. If all nodes are marked, end the algorithm execution, since G is connected. Otherwise, run a minimum spanning tree algorithm (MST) such as, for example, a Kruskal algorithm for example which runs in polynomial time, on the original problem and insert any edge of the MST such that the vertices belong to different connected components in G. By repeatedly inserting edges while G is infeasible, the graph will eventually become connected. In other words, as any MST comprises the minimum-weighted connected graph of a given graph, this approach may first obtain the MST of the original problem. Secondly, the cheapest edge, that is, the shortest edge in terms of time, distance, and/or other parameter, of the MST that connects two disconnected components of G is inserted into G. This process is repeated until G becomes feasible.

Note that in inserting edges between nodes, an embodiment may seek to identify the minimum distance/time/other relating to movement between those nodes. Further, no particular order of edge insertion is necessarily required. Since only a few edges may need to be inserted, a brute force approach can be taken which considers every possible edge insertion option.

A demonstration of an example of the edge insertion procedure is disclosed in FIGS. 4a, 4b, 4c, and 4d, which generally disclose an example of an MST-based repair procedure 400 for infeasible graphs. In particular, the edge insertion procedure of FIGS. 4a-4d is implemented using two pallet delivery tasks with picking, or starting point, and delivery, or ending point, in a warehouse represented as graph comprising multiple nodes arranged in a grid format. FIGS. 4a and 4b represent, respectively, the original problem in graph and the resulting graph of operation #4 208 in FIG. 2. Note that FIG. 4b contains more than one disconnected component or node, that is, the graph is disconnected,) and as such, the deliveries cannot be performed. In FIG. 4c, an embodiment comprises an MST for the original problem with arbitrarily chosen edges shown in broken lines.

Finally, in FIG. 4d, the remaining edges needed to make the graph a connected graph, that is, each component is connected, may be obtained by iteratively including edges, shown in broken lines, that connect any two components that are disconnected from each other. In FIG. 4d, the cheapest repair options have been selected. Thus, for example, it can be seen, by comparing FIG. 4d with FIG. 4b, that the starting point and ending point for Task #1 are now connected to each other, and the corresponding delivery can thus be made. The same is true for Task #2.

Note that an embodiment of another approach for repairing the graph connectivity comprises adjusting the minimum threshold until a connected graph is obtained. This can be achieved, for example, by using a binary search method to find a threshold that makes the graph connected. This trial-and-error approach, however, may be time consuming since it may require many steps to refine the threshold and to test the graph connectivity. In an embodiment however, this process could be parallelized, and stopped once a node finds a feasible graph with a minimum threshold, thus providing a more efficient implementation of the trial-and-error approach.

### D. Example Methods

It is noted with respect to the disclosed methods, including the example method 200 of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: obtaining a group of historical itineraries, where each itinerary in the group of historical itineraries identifies a route previously taken by a vehicle in an operating environment; generating a heatmap using a model that aggregates the historical itineraries and one or more changes that have occurred in the operating environment since the historical itineraries were generated; deriving a graph from the heatmap, wherein the graph defines a routing problem and comprises a subset of the group of historical itineraries; and using the graph to generate updated itineraries that account for the one or more changes in the operating environment.

Embodiment 2. The method as recited in any preceding embodiment, wherein the heatmap comprises an adjacency matrix of cells containing values that each represent a parameter of a movement of a vehicle between two nodes in the operating environment.

Embodiment 3. The method as recited in embodiment 2, wherein, in the graph, an edge between two nodes of a pair of nodes exists if a corresponding cell in the heatmap has a value greater than a minimum threshold.

Embodiment 4. The method as recited in any preceding embodiment, wherein the graph generated based on the historical edges includes fewer edges than a fully connected graph.

Embodiment 5. The method as recited in any preceding embodiment, wherein the subset of historical itineraries is generated based on the changes that have occurred in the operating environment.

Embodiment 6. The method as recited in any preceding embodiment, wherein a graph repair procedure is performed when the graph is disconnected.

Embodiment 7. The method as recited in embodiment 6, wherein the graph repair procedure comprises inserting edges between unconnected nodes of the graph until all the nodes are connected by cheapest edges.

Embodiment 8. The method as recited in embodiment 7, wherein one of the unconnected nodes represents a break in an itinerary for a vehicle that has been assigned a task involving movement of the vehicle to and/or from the unconnected node.

Embodiment 9. The method as recited in any preceding embodiment, wherein one of the vehicles is an autonomous vehicle.

Embodiment 10. The method as recited in any preceding embodiment, wherein the updated itineraries are provided to the vehicles.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

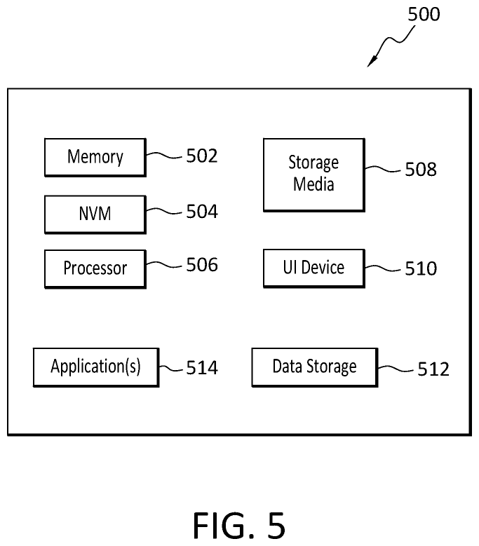

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
obtaining a group of historical itineraries, where each itinerary in the group of historical itineraries identifies a route previously taken by a vehicle in an operating environment;
generating a heatmap using a model that aggregates the historical itineraries and one or more changes that have occurred in the operating environment since the historical itineraries were generated;
deriving a graph from the heatmap, wherein the graph defines a routing problem and comprises a subset of the group of historical itineraries; and
using the graph to generate updated itineraries that account for the one or more changes in the operating environment.

2. The method as recited in claim 1, wherein the heatmap comprises an adjacency matrix of cells containing values that each represent a parameter of a movement of a vehicle between two nodes in the operating environment.

3. The method as recited in claim 2, wherein, in the graph, an edge between two nodes of a pair of nodes exists if a corresponding cell in the heatmap has a value greater than a minimum threshold.

4. The method as recited in claim 1, wherein the graph generated based on the historical edges includes fewer edges than a fully connected graph.

5. The method as recited in claim 1, wherein the subset of historical itineraries is generated based on the changes that have occurred in the operating environment.

6. The method as recited in claim 1, wherein a graph repair procedure is performed when the graph is disconnected.

7. The method as recited in claim 6, wherein the graph repair procedure comprises inserting edges between unconnected nodes of the graph until all the nodes are connected by cheapest edges.

8. The method as recited in claim 7, wherein one of the unconnected nodes represents a break in an itinerary for a vehicle that has been assigned a task involving movement of the vehicle to and/or from the unconnected node.

9. The method as recited in claim 1, wherein one of the vehicles is an autonomous vehicle.

10. The method as recited in claim 1, wherein the updated itineraries are provided to the vehicles.

11. A non-transitory storage medium having stored therein instructions that are executable by one or more hardware processors to perform operations comprising:
obtaining a group of historical itineraries, where each itinerary in the group of historical itineraries identifies a route previously taken by a vehicle in an operating environment;
generating a heatmap using a model that aggregates the historical itineraries and one or more changes that have occurred in the operating environment since the historical itineraries were generated;
deriving a graph from the heatmap, wherein the graph defines a routing problem and comprises a subset of the group of historical itineraries; and
using the graph to generate updated itineraries that account for the one or more changes in the operating environment.

12. The non-transitory storage medium as recited in claim 11, wherein the heatmap comprises an adjacency matrix of cells containing values that each represent a parameter of a movement of a vehicle between two nodes in the operating environment.

13. The non-transitory storage medium as recited in claim 12, wherein, in the graph, an edge between two nodes of a pair of nodes exists if a corresponding cell in the heatmap has a value greater than a minimum threshold.

14. The non-transitory storage medium as recited in claim 11, wherein the graph generated based on the historical edges includes fewer edges than a fully connected graph.

15. The non-transitory storage medium as recited in claim 11, wherein the subset of historical itineraries is generated based on the changes that have occurred in the operating environment.

16. The non-transitory storage medium as recited in claim 11, wherein a graph repair procedure is performed when the graph is disconnected.

17. The non-transitory storage medium as recited in claim 16, wherein the graph repair procedure comprises inserting edges between unconnected nodes of the graph until all the nodes are connected by cheapest edges.

18. The non-transitory storage medium as recited in claim 17, wherein one of the unconnected nodes represents a break in an itinerary for a vehicle that has been assigned a task involving movement of the vehicle to and/or from the unconnected node.

19. The non-transitory storage medium as recited in claim 11, wherein one of the vehicles is an autonomous vehicle.

20. The non-transitory storage medium as recited in claim 11, wherein the updated itineraries are provided to the vehicles.
